(19) United States
(12) Patent Application Publication
(10) Pub. No.: US 2003/0154080 A1
(43) Pub. Date: Aug. 14, 2003

(54) Method and apparatus for modification of audio input to a data processing system

(76) Inventors: Sandra L. Godsey, San Diego, CA (US); Chienchung Chang, Rancho Santa Fe, CA (US); Carola R. Emelius-Swartz, Ramona, CA (US)

Correspondence Address: Qualcomm Incorporated, Patents Department, 5775 Morehouse Drive, San Diego, CA, 92121-1714, US

(21) Appl. No.: 10/075,323

(22) Filed: Feb. 14, 2002

(51) Int. Cl. G10L 15/04; G10L 15/00

(52) U.S. Cl. 704/251

(57) ABSTRACT

Method and apparatus for modifying a speech input to generate a desired speech output. A voice recognition unit analyzes the speech input and generates a textual output. The output is used by a speech synthesis unit to generate an output speech signal using speech characteristics and parameters stored in a database. The database may be preconfigured to store speech characteristics of a variety of types. A training unit allows the user to enter speech samples which are used to generate inputs to the database. The training unit acquires the speech samples and generates speech units, such as diphones, which may be modified to achieve a desired result. In one embodiment, the modified speech output is applied to an STU program, and feedback is provided indicating the error rate.

### BACKGROUND OF THE INVENTION

1. Field of the Invention

The present invention relates to communications and specifically to methods and apparatus for modifying audio inputs to a data processing system.

2. Description of the Related Art

A typical data processing system may include the capability for processing a variety of data types, including both digital and analog information. Often the system is also capable of receiving and/or outputting both digital and analog signals. Of particular application is the ability to process audio information such as voice or music. Historically, the processing of audio signals incurred significant delays into the operation of a data processing system. Recent trends have increased the processing speed and in response the market for such processing is growing exponentially. There is a corresponding need for increases in the flexibility and potential of audio processing abilities.

As wireless communications in particular increase, the ability of users to interface with people in a variety of geographical locations increases. Parties to such communication may use a second language or have regional accents and/or dialects. In such situations, clear communication may be a challenge. There is a need, therefore, to reduce misunderstandings and communication errors resulting from the distortions introduced by individual speakers.

Further, for telephonic communications, without a face-to-face meeting the only presentation made by the speaker to the listener is the sound and manner of the speaker's voice. Therefore, there is a need to enhance the presentation of a speaker's voice.

### BRIEF DESCRIPTION OF THE DRAWINGS

The features, nature, and advantages of the present invention will become more apparent from the detailed description set forth below when taken in conjunction with the drawings in which like reference characters identify correspondingly throughout and wherein:

FIG. 1 is a block diagram of a voice recognition model;

FIG. 2 is a block diagram of a speech synthesis model;

FIG. 3 is a block diagram of a speech modification system;

FIG. 4 is a block diagram of a speech synthesis unit;

FIG. 5 is a block diagram of a communication device;

FIG. 6 is a block diagram of an audio signal modification system, including language translation capabilities;

FIG. 7 is a flow diagram of a method for operation of speech modification system;

FIG. 8 is a timing diagram of a speech signal illustrating diphone partitioning; and

FIG. 9 is a block diagram of a voice modification system adapted for generating a musical output.

### DETAILED DESCRIPTION OF VARIOUS EMBODIMENTS

The exemplary embodiments illustrate a voice modification system applicable to a wireless communication system. The voice modification system includes a voice recognition unit and a speech synthesis unit, wherein an input audio signal is first analyzed by the VR unit, and the result is provided to the speech synthesis unit. The user may select from the desired modification. In one embodiment, the user may select from a variety of voice types, such as male, female, etc., wherein a voice is generated independent of the speech characteristics of the user's voice. In contrast, the user may select to have the input voice modified to result in a speech output that sounds different from the spoken input.

According to one embodiment, the voice modification system includes a translation unit, wherein the voice input may be provided in a first language, and the translation unit performs a translation to a second language, wherein the speech output is of the translated version, i.e., in the second language. The user may select from a variety of voice types for outputting the translated version.

For clarity of understanding, the following discussion introduces each of the components of the voice modification system. Voice recognition and speech synthesis are discussed generally with respect to common models as exemplars. Alternate models, algorithms, methods, and apparatus are applicable to voice modification.

Voice Recognition

Voice recognition (VR), or speech recognition, refers to the automatic recognition of speech by machine. Various models have been, and continue to be, developed for meeting the challenges of VR. Such models include: signal processing using spectral analysis to characterize the time-varying properties of the speech signal; pattern recognition using a set of algorithms to cluster data and create patterns; communication and information theory using methods for estimating parameters of statistical models to detect the presence of speech patterns; as well as others.

Voice recognition (VR) represents one of the most important techniques to endow a machine with simulated intelligence to recognize user or user-voiced commands and to facilitate human interface with the machine.

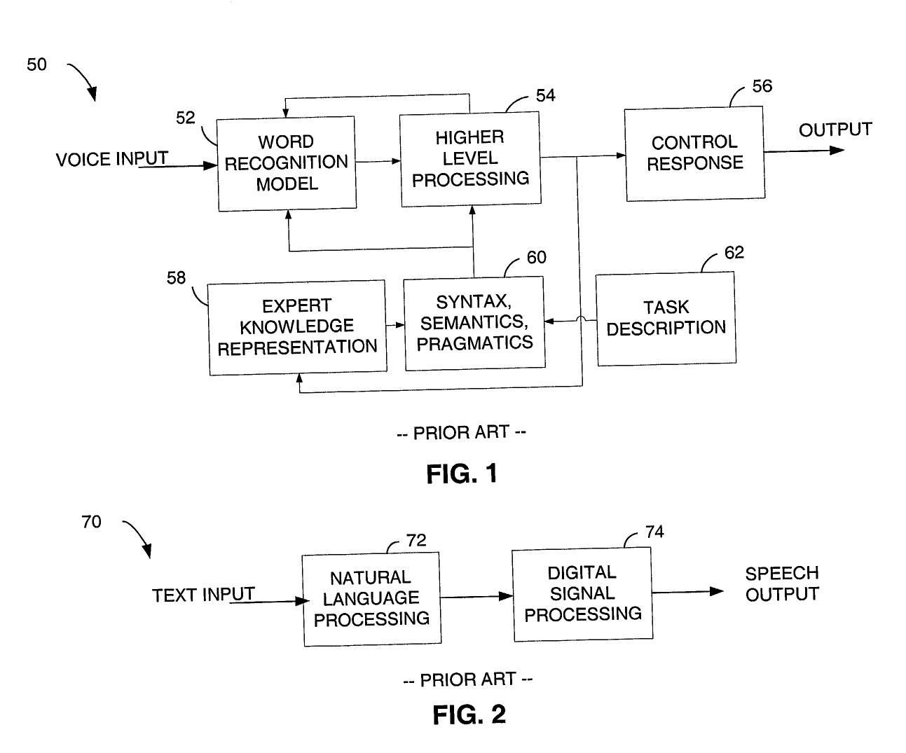

FIG. 1 illustrates a general model for speech recognition as described in Fundamentals of Speech Recognition by Lawrence Rabiner and Biing-Hwang Juang, Prentice Hall, Englewood Cliffs, N.J., 1993, p. 3. As illustrated, the model 50 receives a voice, speech, or other audio input from a user. The voice input provided by the user is intended to accomplish a given task. The task may be to perform a predetermined function, such as placing a telephone call to a known number, or may be to generate a textual output for display on a computer screen, or any other voice command task. The voice input is provided to a word recognition model 52, which recognizes the voice signal. The word recognition model 52 decodes the voice signal into a series of words. The series of words are meaningful according to the syntax, semantics, and pragmatics (i.e., rules) of the recognition task. These rules are specific to the processing system and application of the voice recognition system.

Continuing with the model of FIG. 1, the meaning of the recognized words is then determined by the higher level processing 54. The higher level processing unit 54 uses an expert knowledge representation 58 to modify the rules (e.g., syntax, semantics, and pragmatics) according to the context of the words recognized. The rules are represented as syntax, semantics, pragmatics 60, and are provided to both the higher level processing 54 and the word recognition model 52. The expert knowledge representation 58 assists in eliminating meaningless series of words. Feedback from the higher level processing 54 is provided to the word recognition model 52, assisting in refining the recognition process. Task description 62 provides information to the model related to the tasks corresponding to various voice inputs. The model then outputs control signals for performing the task. For example, in an automated dictation system, the output provides control signals to display the text recognized from the voice input.

VR devices are classified as either speaker-dependent or speaker-independent devices. Speaker-independent devices are capable of accepting voice commands from any user. Speaker-dependent devices, which are more common, are trained to recognize commands from particular users. A speaker-dependent VR device typically operates in two phases, a training phase and a recognition phase. In the training phase, the VR system prompts the user to provide a speech sample to allow the system to learn the characteristics of the user's speech. For example, for a phonetic VR device, training is accomplished by reading one or more brief articles specifically scripted to cover all of the phonemes in the language. The characteristics of the user's speech is then stored in VR templates. In operating mode, the VR device receives an unknown input from the user and accesses the VR templates to find a match. There are a variety of methods for implementing a VR system.

Speech Synthesis

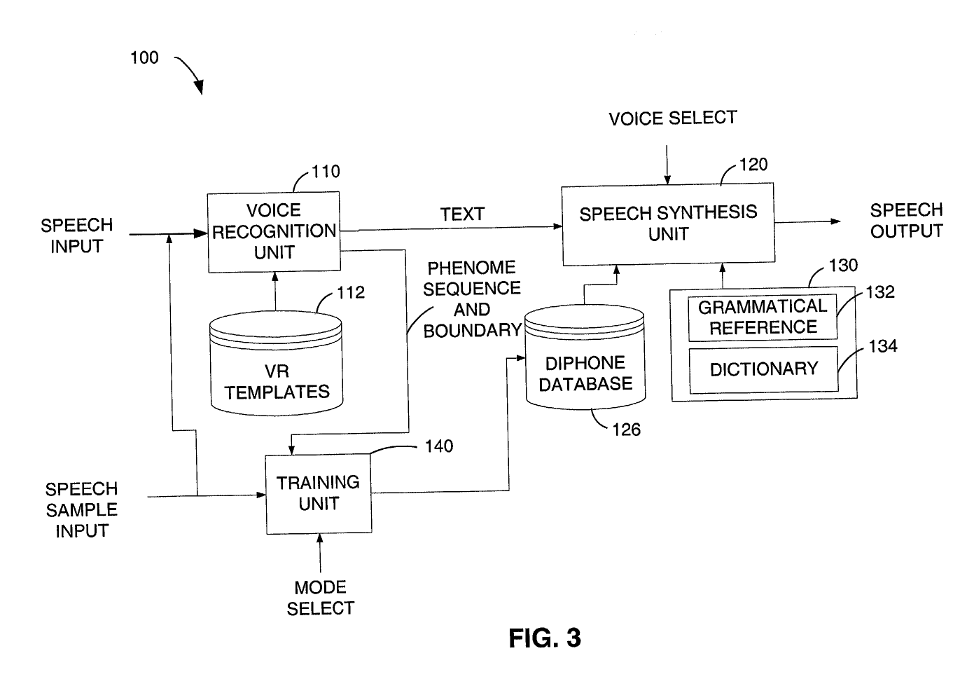

A speech synthesizer is a computer-based system that provides an audio output (i.e., synthesized speech signal) in response to a text or digital input. The speech synthesizer provides automatic audio production of new sentences. FIG. 2 illustrates a model of a speech synthesizer. The model 70 includes natural language processing 72 and digital signal processing 74. The natural language processing 72 receives a textual or other non-speech input and produces a phonetic transcription in response. The natural language processing 72 also provides the desired intonation and rhythm (often termed as prosody) for digital signal processing 74, which transforms the symbolic information it receives into speech. The natural language processing 72 involves organizing input sentences into manageable lists of words, identifying numbers, abbreviations, acronyms and idiomatics, and transforming individual components into full text. The natural language processing 72 proposes all possible part of speech categories for each word taken individually, on the basis of their spelling. Contextual analysis then considers words in their context, allowing reduction of the analysis to highly probable hypotheses. Finally, the syntactic-prosodic parsing is performed to find text structure (i.e. organization into clause and phrase-like constituents).

The natural language processing 72 further provides automatic determination of the phonetic transcription of the incoming text, and generates correct prosody. The term prosody refers to certain properties of the speech signal related to audible changes in pitch, loudness, and syllable length. For instance, there are certain pitch events which make a syllable stand out within an utterance, and indirectly the word or syntactic group it belongs to will be highlighted as an important or new component in the meaning of that utterance.

The digital signal processing 74 provides the audio output and is the digital analogue of dynamically controlling the human vocal apparatus. The digital signal processing 74 utilizes information stored in databases for quick retrieval. The stored information represents speech units. Some speech units commonly used include, but are not limited to: acoustic units, referred to as phonemes or phones; diphones or units that begin in the middle of a stable state of a phone and end in the middle of the following one; half-syllables; and triphones or units similar to diphones but including a central phone.

Speech Modification

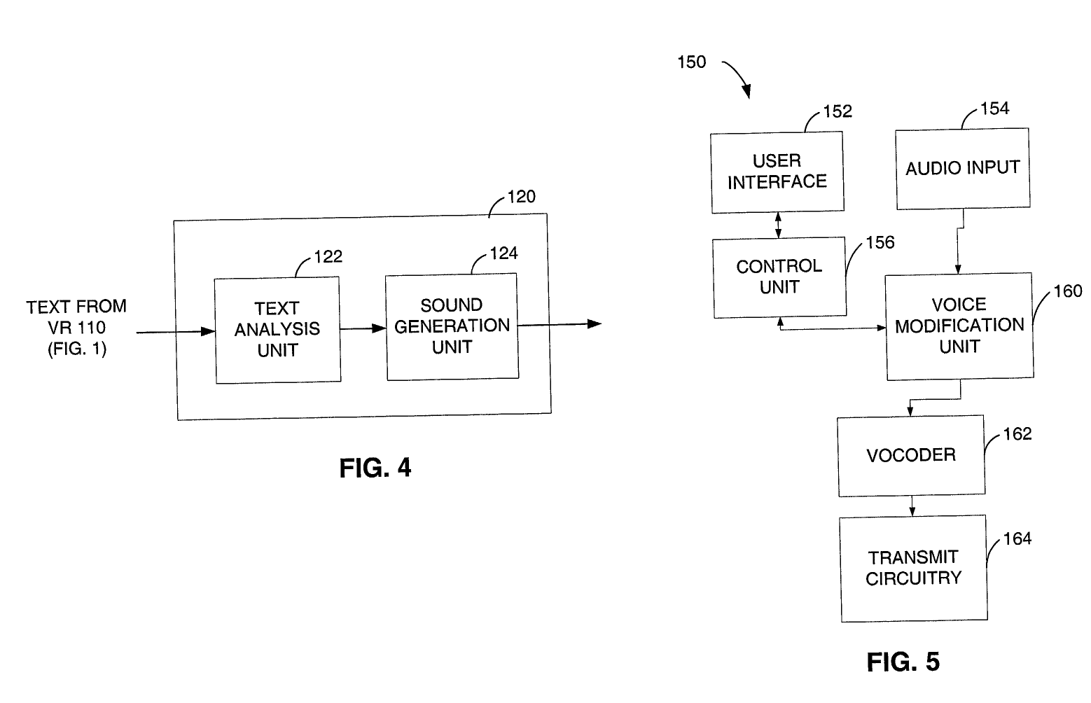

FIG. 3 illustrates a speech modification unit 100, including both a voice recognition unit 110 and a speech synthesis unit 120. According to the exemplary embodiment, the speech modification unit 100 may be applicable to a wireless communication device, such as illustrated in FIG. 3, discussed hereinbelow. The speech modification unit 100 is adapted to receive an audio input, such as a user's speech, and provide a modified speech output. The modified speech output may be a function of the user's original speech input, or may be a different voice. The user selects the desired modification prior to speech input. The modifications available are each stored in a database, and retrieved during operation.

As illustrated in FIG. 3, a speech input is provided to VR Unit 110 and converted to a text output. The VRU 100 is coupled to a set of VR templates 112, which are used for comparison to the speech input. The VR templates 112 may be generated during a training stage, wherein a user provides voice samples, such as for a speaker-dependent VR system; or the VR templates 112 may be predetermined based on known statistical models of user speech, such as for a speaker-independent VR system. An alternate embodiment employs a speaker-adapted VR process. A variety of methods and algorithms are available for processing the speech input to provide a text output. For example, an LPC-based acoustic processor includes an acoustic pattern matching element to detect and classify acoustic patterns, such as phenomes, syllables, words, etc. The candidate patterns are provided to a language modeling element which models the rules of syntactic constraints that determine what sequences of words are grammatically well formed and meaningful. Syntactic information can be a valuable guide to voice recognition when acoustic information alone is ambiguous. Based on language modeling, the VR sequentially interprets the acoustic feature matching results and provides the estimated word string. Both the acoustic pattern matching and language modeling require mathematical models, either deterministic or stochastic, to describe the speaker's phenological and acoustic-phonetic variations. Performance of a speech recognition system is directly related to the quality of the two modelings. Various voice recognition systems are described in U.S. Pat. No. 5,956,683 entitled “Distributed Voice Recognition System,” by Jacobs, et al., assigned to the assignee hereof, and hereby expressly incorporated by reference herein.

Continuing with FIG. 3, the text output is provided to speech synthesis unit 120. Speech synthesis unit 120 processed the text received to generate a speech output. The speech synthesis unit 120 is responsive to a voice select control signal provided by the user. The voice select control signal instructs the speech synthesizer unit 120 to select a specific set of speech characteristics from a database, such as diphone database 126. The VR unit 110 also provides phenome sequence and boundary information to the training unit 140. During training mode, the speech sample input to training unit 140 is also provided to VR unit 110. The VR unit 110 processes the speech sample input, providing the phenome information to training unit 140. In one embodiment, a mode select is provided to the VR unit 110 to indicate training mode or normal operation. Note that alternate embodiments may use the phenome information during operations other than training.

Information is stored in the diphone database 126 during an acquisition stage. Speech samples are provided to a training unit 140, which cuts the speech samples to select acoustic units, such as diphones, for storage in the diphone database 26. A mode control signal is provided to the training unit 140 by the user to initiate an acquisition mode. Alternate embodiments may implement a database storing alternate types of speech information, such as Pulse Code Modulated (PCM) samples, compressed speech samples, etc. The function of the training unit 140 is determined by the type of speech information stored. The speech information is used in combination with information stored in grammatical reference 132 and dictionary 134 to generate the speech output.

Training to develop the diphone database 126, or any other database storing information that is used to reconstruct or build speech in speech synthesis unit 120, may be performed “on-line” or “off-line”. On-line training refers to the user speaking into the device, and the device recording the user's voice. From this speech, the diphones are extracted and stored in database 126. Off-line refers to downloading or otherwise providing the voice pattern from a memory storage device, computer, the Internet, or other source. Note that training may utilize the user's voice, wherein the speaker's voice is provided in real-time or from a recording, i.e., on-line or off-line. Similarly, the voice of another may be used to train the diphone database, such as from a recording or downloaded from a computer, memory storage device, the Internet, etc.

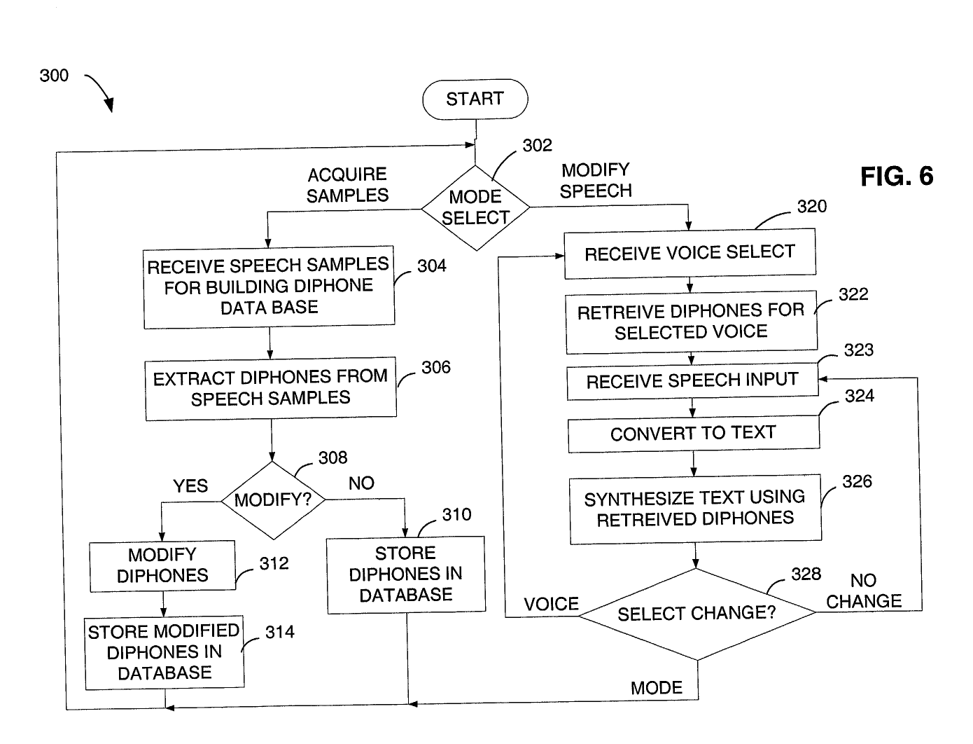

Speech synthesizer 120 is further detailed in FIG. 4 having a text analysis unit 122 and a sound generation unit 124, similar to the model illustrated in FIG. 2. The text analysis unit 122 uses information from the linguistic parameters 130, including, but not limited to, grammatical reference 132 and dictionary 134 to develop a speech pattern. The sound generation unit 124 uses information from the diphone database 126 to implement the speech pattern and generate a speech output.

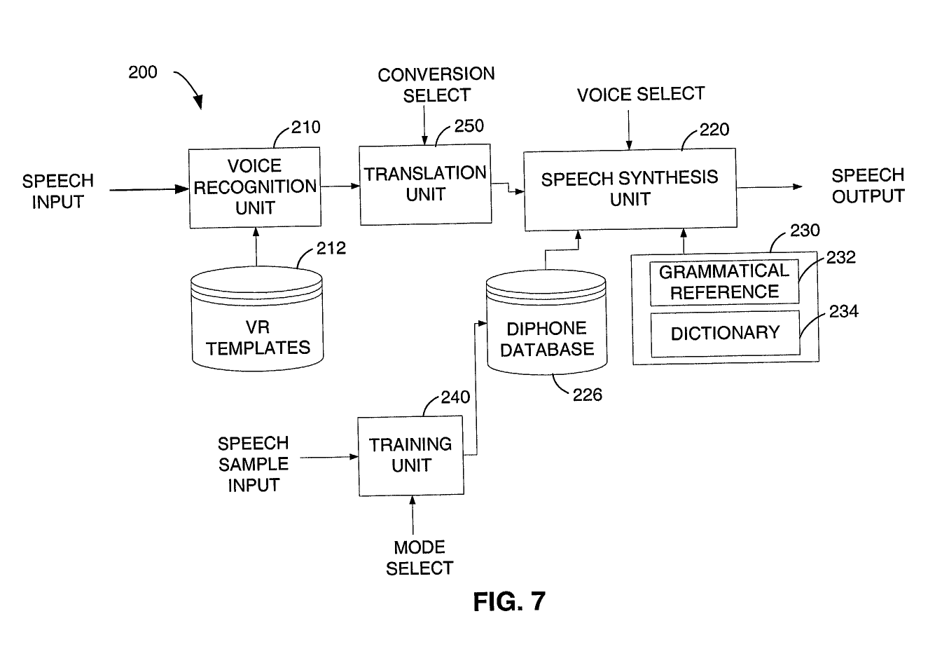

FIG. 5 illustrates configuration of a voice modification unit 160, similar to voice modification unit 100 of FIG. 3, within a communication device 150, such as a wireless communication device. As illustrated, the communication device 150 includes a user interface 152, which may include a display for providing instructions and status messages to a user. The user interface 152 may also include an input mechanism, such as a keypad, allowing the user to enter commands and respond to queries. The user interface is bi-directionally coupled to a control unit 156, wherein the control unit 156 provides control signals for operation of the user interface and receives inputs from the user. The control unit 156 is bi-directionally coupled to the voice modification unit 160.

The control unit 156 may provide mode selection and/or voice selection information to the voice modification unit 160. The communication device 150 also includes an audio input 154, such as a microphone, for receiving a user's speech input. The voice modification unit 160 is further coupled to vocoder 162 and in turn to transmit circuitry 164. The vocoder 162 codes the output of the voice modification unit 160 to prepare for transmission over an air interface, such as for a wireless communication. The output of voice modification unit 160 is provided as an analog signal via conductor(s) to vocoder 162. The transmit circuitry 164 provides the speech output signal from the voice modification unit 160 to other modules. In a wireless communication device, the transmit circuitry 164 provides the speech output signals on an airlink to an intended recipient. Note that the vocoder 162 and transmit circuitry 164 are optional blocks included in a wireless communication device.

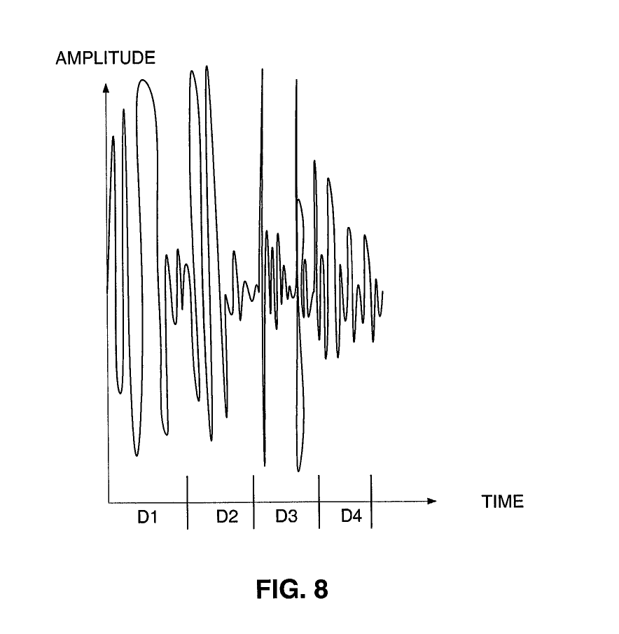

Operation of communication device 150, and specifically of speech modification unit 100, 160, is illustrated in FIG. 6. The process 300 begins by determining an operational mode of the voice modification unit at decision diamond 302 If the user has indicated acquisition mode, i.e., the system will acquire voice samples, processing continues to step 304 to receive speech samples for building the diphone database. The voice modification unit extracts the diphones from the speech samples at step 306 and determines if the diphones are to be modified at decision diamond 312. If the user has indicated that input speech samples are to be modified, the unit modifies the diphones at step 312 and stores the modified diphones in the database at step 314. Modification may involve any of a variety of alterations of the input speech samples. For example, the input speech samples may be compared to a predetermined speech target. Spectral components not consistent with the predetermined speech target are evaluated, and if there is too great an inconsistency, these components are made to conform to the predetermined speech target. In another example, accent acoustics are identified and removed from the speech sample. Any of a variety of desired effects may be achieved by modification of the input speech sample.

Returning to decision diamond 302, for speech processing, to modify speech input, processing continues to step 320 to receive a voice select control signal. The voice select determines the characteristics of the output speech. For example, in one embodiment, the user may select between a newscaster, a movie star, and a politician with a familiar voice. Any number and/or variety of voice types may be present in a given system. The process then retrieves the diphones corresponding to the selected voice type at step 322. At step 323 speech input is received, and converted to text at step 324. At step 326 the text is synthesized using the retrieved diphones to generate a speech output signal. The process then determines if a select control has changed at decision diamond 328. If the voice type select has changed, the process returns to step 320. If the operating mode has changed, processing returns to decision diamond 302. If there is no change in the select controls, processing continues to step 323 to receive speech inputs.

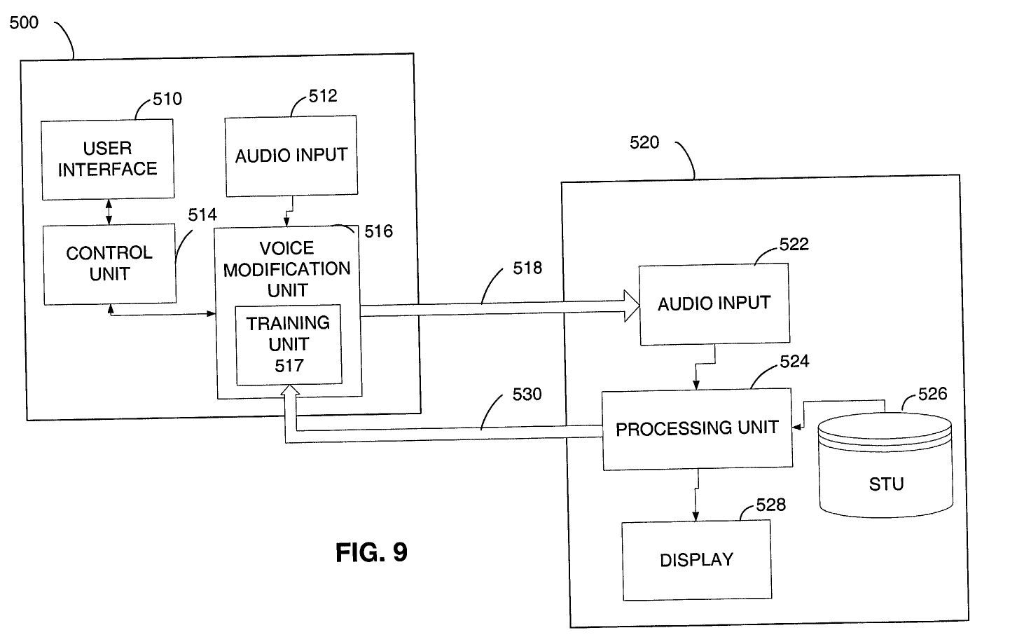

FIG. 7 illustrates one embodiment of a voice modification system 200 having a translation unit 250 coupled between voice recognition unit 210 and speech synthesis unit 220. The user provides a conversion select control signal to enable the translation capability of the system, and to select the particular conversion desired. The user may then provide speech input in a first language with resultant speech output in a second language. The user provides speech input as an analog signal to the voice recognition unit 210. By first providing a voice recognized textual version of the speech input, i.e., the output of voice recognition unit 210, the text is available for translation into another language. The conversion select control signal is coordinated with the voice select control signal, so as to provide a desired speaker voice for the translation. Similarly, the user indicates to the voice recognition unit 210 which templates within VR templates 212 to use. Note that one embodiment includes several databases of VR templates, wherein a control signal (not shown) is provided for selection. An alternate embodiment specifies an input language, wherein, for example, the user must enter the speech input in English. The conversion select control signal selects the appropriate mapping from the input language to a target language. The voice select control signal selects the specifics of the output voice. For example, one embodiment may allow the user to select French to English translation for the conversion select control, and also to select among British polite, American business, etc. for the voice select. For a selection of American business, for example, the user's original speech input in French is translated to English, and then pronunciation, accent, etc. of American business English would be used to generate the synthesized speech.

The translation unit 250 receives a textual output from the voice recognition unit 210; in response, the translation unit 250 translates the received text and provides a textual output, i.e., the translation, to speech synthesis unit 220. The speech synthesis unit 220 retrieves the appropriate information from diphone database 226 and linguistic parameters 230. As illustrated, linguistic parameters 230 includes grammatical reference 232 and dictionary 234, but may include any number of other references enhancing the performance of speech synthesis unit 220. One embodiment provides separate sets of diphone database 226 and linguistic parameters 230 for each language supported by the voice modification unit 200. A training unit 240 is also provided, wherein a speech sample input may be used to generate entries in the diphone database. By allowing a user to provide diphones of their own voice, the speech synthesis unit 120 is able to construct a speech output using the parameters of the user's voice. This capability allows the recipient of the voice communication to hear the user speak in the second language. In other words, the effect is to imitate the user's actual voice in a second language. Note that compilation of sufficient diphones for each of the languages supported by the voice modification unit 200 may require the user to enter diphones that are not included in the user's primary language. For example, for translation from English to Chinese, a native English speaker will enter those diphones not available in English. Once the Chinese diphone database is compiled, the user may speak in English and be heard in the same voice in Chinese.

In one embodiment, the translation unit is not included within the voice modification unit 200, but rather is provided externally, wherein the translation unit may be coupled to the voice recognition unit 210 and the speech synthesis unit 220. The translation unit is provided as a plug-in, allowing the user to change the translation capabilities of the voice modification unit 200. For example, a user may desire to use additional languages. Similarly, the user may desire a more accurate translator. In each of these cases, as the technology advances, the user is able to replace the translation unit without replacing the voice modification unit 200.

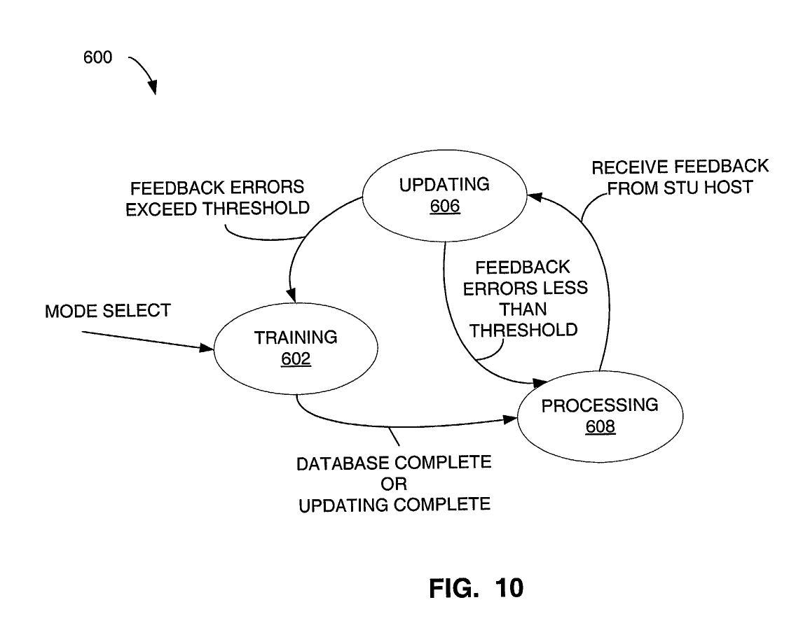

Returning to FIG. 3, speech modification unit 100, in an acquisition mode, a speech sample input is entered to the training unit 140. An example of a speech sample input is illustrated in FIG. 8, and will be used for discussion of the training unit 140. The vertical axis indicates the amplitude of the input signal, and the horizontal axis indicates time. The training unit 140 of FIG. 3 receives a speech input signal and identifies predetermined portions or segments of the input pattern. In the exemplary embodiment, the training unit 140 identifies diphones. A diphone is loosely, either two phones or 2 phonemes, or some combination of 2 sounds in spoken language. Alternate embodiments may use other portions or segments which allow reconstruction of speech, i.e., any of the abstract units of the phonetic system of a language that correspond to a set of similar speech sounds.

The basic concept of a diphone database 126 is to explicitly list all possible phone-phone transitions in a language. The exact definition of a phone and a diphone are specific to each language and even to each implementation of a speech synthesis system. In a diphone database only one occurrence of each diphone is recorded. This makes selection much easier but also may render the collection or acquisition task difficult.

In general, the number of diphones in a language is the square of the number of phones. However, in natural human languages, there are constraints on some phone-phone pairs, wherein even whole classes of phones-phone combinations may not occur at all. These gaps are common in the world's languages.

In one example, illustrated in FIG. 8, the speech input signal is cut or divided on diphone transitions. The first diphone is identified as D1, the second diphone is identified as D2, the third diphone is identified as D3, and the fourth diphone is identified as D4. Each diphone is extracted from the speech input signal. The diphones are labeled and stored in the diphone database 126. The speech synthesis unit 120 retrieves the diphones as needed to respond to the textual output received from the voice recognition unit 110.

For modification of the speech input signal, the training unit 140 may apply an algorithm or process for smoothing the voice to remove irregularities or other undesirable effects in the voice. In one embodiment, the training unit 140 is programmed to recognize a particular accent or accents; specifically, the training unit 140 identifies speech patterns associated with a given accent. The training unit 140 then removes these specific patterns from the speech signal. The modified speech signal is then provided to the diphone database 126.

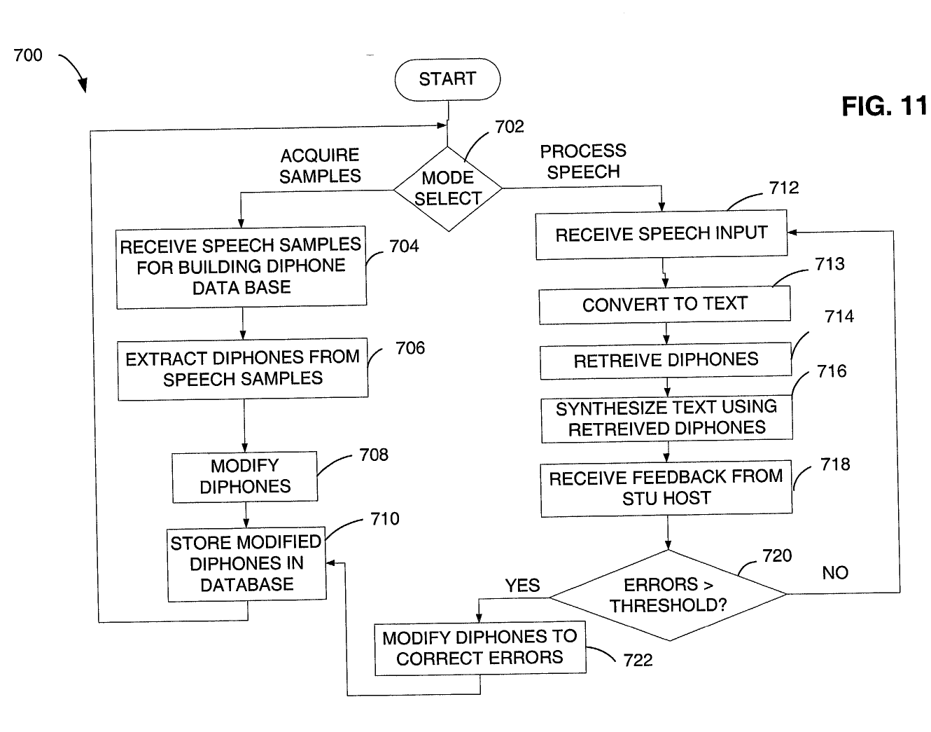

FIG. 9 illustrates one embodiment of a voice modification device 500 adapted for operation with a speech-to-text processing system, such as a dictation program running on a personal computer, or other device that receives an input speech signal and generates a textual or command response. As many speech-to-text, and other speech activated programs, use voice recognition algorithms to process the speech input, the accuracy is typically related to the complexity and expense of the product. The less complicated, and more affordable, systems tend to be unforgiving of irregularities in the speech input. The voice modification device 500 may be applied to smooth the user's voice, and thus allow more accurate voice recognition by the less complex systems. For example, a non-native English speaker using an English speech-to-text system may experience inaccuracies even in a complicated program due to a heavy accent or different intonation. By application of the voice modification device 500, the user may increase the accuracy of such programs without modifying the speech-to-text program directly.

The voice modification device 500 includes a user interface 510 coupled to a control unit 514. The control unit 514 provides the user selections and commands to the voice modification unit 516. The user may select a training mode, referred to as an acquisition mode, or normal operation. Alternate embodiments may allow additional control and instruction specific to the type of modification and the parameters of modification, such as removing certain frequencies from the speech input, etc. An audio input 512 is coupled to the voice modification unit 516, wherein the speech input is provided via the audio input 512. The voice modification unit 516 is similar to voice modification unit 100 of FIG. 3, having a training unit 517, similar to training unit 140. Training unit 517 operates in one of several modes: a first training mode wherein the speech input signal is evaluated and the diphones extracted; a modification mode wherein the extracted diphones are modified to achieve a desired effect, such as removal of irregularities; an update mode wherein input is received from a Speech-To-Text (STU) application and the extracted (and possibly modified) diphones are updated to reduce errors when applied to the STU; and an idle mode wherein the voice modification unit 516 is processing a speech input using the diphone database (not shown) or is the voice modification device is receiving feedback information from the application host. The training mode is typically initiated by the user, whereas the update mode is typically in response to a feedback from the application host.

The voice modification unit 516 processes speech inputs and provides the resultant speech output via conductor(s) 518 to an application host. The application host is the processing unit that will operate the STU, or other speech-activated, program. In the example illustrated in FIG. 9, the application host is a personal computer 520 having a processing unit 524 and resident STU software 526. The computer 520 further includes an audio input 522 and a display 528, each coupled to the processing unit 524. The computer 520 receives the speech output of voice modification unit 516 and applies the STU program to generate a textual output on the display 528. The text displayed is the conversion of the speech output signal to text. The computer 520 also provides feedback information to the voice modification device 500 indicating the number of errors and/or inaccuracies in the resultant text. Such feedback information may be a copy of the textual output displayed on display 528, or may be an error indicator. In the exemplary embodiment, the computer 520 provides the displayed text as feedback. The feedback is then compared to the originally received input to the voice modification device 500. While the original input to the voice modification device 500 was an audio input (analog), the voice modification unit 516 includes a voice recognition unit (not shown), wherein prior to speech synthesis the original audio input was converted to text. This original text version is stored and used for comparison to the feedback information from the computer 520. Alternate embodiments may apply any of a variety of error determination methods.

The comparison is used to determine the level of error and/or inaccuracy of the STU application using the modified voice signals. The result of the comparison is provided to the training unit 517. When the errors exceed a threshold, the stored diphones are updated to correct the errors.

FIG. 10 is a state diagram of operation 600 of the voice modification device 500 according to one embodiment. Mode selection by the user will initiate a training mode 602, wherein, as discussed hereinabove, the user may provide a speech input to acquire diphones for a database. During the training mode 602, the diphones may be modified to remove irregularities. Upon completion of the diphone database, the voice modification device 500 transitions to processing mode 608. During processing mode 608, the voice modification device 500 receives speech input and applies the diphones stored in the database to generate a modified speech output. When the voice modification device 500 receives feedback from an application host, the voice modification device 500 transitions to an update mode 606. During the update mode 606, the feedback is evaluated to determine if errors exceed a predetermined threshold. If the errors do not exceed the threshold, the voice modification device 500 transitions back to processing mode 608. If errors exceed the threshold, the voice modification device 500 transitions to training mode 602, wherein the diphones are updated to reduce the errors to below the threshold. When the updating is completed, the voice modification device 500 transitions to processing mode 608.

FIG. 11 illustrates, in flow diagram form, operation 700 of voice modification device 500. As illustrated, the process starts by mode selection by the user at decision diamond 702. For training mode, processing continues to step 704 to receive speech samples for building the diphone database. The initial acquisition of speech samples is required at least once. The diphones are extracted from the speech sample at step 706 and modified at step 708. The modified diphones are then stored in the diphone database at step 710, whereupon processing returns to mode selection of decision diamond 702. For normal operation or speech processing, a speech input is received at step 712. The speech input is converted to text at step 713. At step 714 the corresponding diphones are retrieved from the database. At step 716 the text is synthesized using the retrieved diphones. At step 718 feedback is received from the STU host, and if the errors exceed a threshold at decision diamond 720, the diphones are modified at step 722. If the errors do not exceed a threshold, then processing returns to step 712. Note that the feedback from the STU host as well as the updating of the diphones may be optional steps.

The present invention provides a method of modifying a speech input to generate a desired speech output. In one embodiment, a voice recognition unit analyzes the speech input and generates a textual output. The output is used by a speech synthesis unit to generate an output speech signal using speech characteristics and parameters stored in a database. The database may be preconfigured to store speech characteristics of a variety of types. A training unit allows the user to enter speech samples used to generate inputs to the database. The training unit acquires the speech samples and generates speech units, such as diphones. The speech units may be modified to achieve a desired result and/or remove irregularities from the input speech. In one embodiment, the modified speech output is applied to an STU program, and feedback is provided indicating the error rate. In another embodiment, the voice modification unit is part of a wireless communication device, wherein the user may modify the user's voice to achieve a desired presentation to listeners. Thus, a novel and improved method and apparatus for speech processing has been presented.

Those of skill in the art would understand that the data, instructions, commands, information, signals, bits, symbols, and chips that may be referenced throughout the above description are advantageously represented by voltages, currents, electromagnetic waves, magnetic fields or particles, optical fields or particles, or any combination thereof. Those of skill would further appreciate that the various illustrative logical blocks, modules, circuits, and algorithm steps described in connection with the embodiments disclosed herein may be implemented as electronic hardware, computer software, or combinations of both. The various illustrative components, blocks, modules, circuits, and steps have been described generally in terms of their functionality. Whether the functionality is implemented as hardware or software depends upon the particular application and design constraints imposed on the overall system. Skilled artisans recognize the interchangeability of hardware and software under these circumstances, and how best to implement the described functionality for each particular application. As examples, the various illustrative logical blocks, modules, circuits, and algorithm steps described in connection with the embodiments disclosed herein may be implemented or performed with a Digital Signal Processor (DSP), an Application Specific Integrated Circuit (ASIC), a Field Programmable Gate Array (FPGA) or other programmable logic device, discrete gate or transistor logic, discrete hardware components such as, e.g., registers and FIFO, a processor executing a set of firmware instructions, any conventional programmable software module and a processor, or any combination thereof designed to perform the functions described herein. The processor may advantageously be a microprocessor, but in the alternative, the processor may be any conventional processor, controller, microcontroller, programmable logic device, array of logic elements, or state machine. The software module could reside in RAM memory, flash memory, ROM memory, EPROM memory, EEPROM memory, registers, hard disk, a removable disk, a CD-ROM, or any other form of storage medium known in the art. An exemplary processor is advantageously coupled to the storage medium so as to read information from, and write information to, the storage medium. In the alternative, the storage medium may be integral to the processor. The processor and the storage medium may reside in an ASIC. The ASIC may reside in a telephone or other user terminal. In the alternative, the processor and the storage medium may reside in a telephone or other user terminal. The processor may be implemented as a combination of a DSP and a microprocessor, or as two microprocessors in conjunction with a DSP core, etc.

Preferred embodiments of the present invention have thus been shown and described. It would be apparent to one of ordinary skill in the art, however, that numerous alterations may be made to the embodiments herein disclosed without departing from the spirit or scope of the invention. Therefore, the present invention is not to be limited except in accordance with the following claims.

What is claimed is:

1. A voice modification apparatus, comprising:
a voice recognition unit adapted to receive a speech input and generate a textual output;
a speech synthesis unit coupled to the voice recognition unit, adapted to receive the textual output and generate a speech output;
a database coupled to the speech synthesis unit, adapted to store speech parameters; and
a training unit adapted to acquire speech samples and provide speech parameters to the database.

2. The apparatus as in claim 1, wherein the speech synthesis unit retrieves the speech parameters from the database.

3. The apparatus as in claim 2, wherein the speech parameters are diphones.

4. The apparatus as in claim 2, wherein the training unit is operative to modify speech parameters of the speech samples and to store the modified speech parameters in the database.

5. The apparatus as in claim 1, further comprising:
linguistic parameter database for storing grammatical reference information and dictionary entries.

6. The apparatus as in claim 1, further comprising:
a translation unit coupled between the voice recognition unit and the speech synthesis unit, adapted to translate an input language into a second language.

7. The apparatus as in claim 1, wherein the training unit is further adapted to update the speech parameters in response to feedback based on the speech output.

8. A method for speech processing, comprising:
receiving an input speech signal;
converting the input speech signal to a textual output;
selecting a desired set of speech parameters; and
synthesizing the textual output using the desired set of speech parameters.

9. The method as in claim 8, further comprising:
receiving speech samples to build a speech parameter database;
extracting speech parameters from the speech samples;
modifying the speech parameters to form modified speech parameters; and
storing the modified speech parameters; and
using the modified speech parameters to synthesize speech.

10. The method as in claim 9, wherein modifying the speech parameters comprises:
comparing the speech samples to a target speech sample; and
removing irregularities from the speech samples.

11. The method as in claim 9, wherein extracting speech parameters comprises:
identifying speech units within the speech samples.

12. The method as in claim 8, further comprising:
receiving feedback information based on application of the speech output;
determining an accuracy of the application of the speech output; and
if the accuracy is less than a predetermined threshold, updating the modified speech parameters

13. An apparatus for speech processing, comprising:
means for receiving an input speech signal;
means for converting the input speech signal to a textual output; and
means for synthesizing the textual output using a desired set of speech parameters.

14. The apparatus as in claim 13, further comprising:
means for receiving speech samples to build a speech parameter database;
means for extracting speech parameters from the speech samples;
means for modifying the speech parameters to form modified speech parameters; and
means for storing the modified speech parameters; and
means for using the modified speech parameters to synthesize speech.

15. A computer software program, operative to perform:
converting an input speech signal to a textual output; and
synthesizing the textual output using a desired set of speech parameters to generate a speech output.

16. A speech modification unit, comprising:
a speech-to-text conversion unit; and
a speech synthesis unit coupled to the speech-to-text conversion unit, the speech synthesis unit applying a plurality of speech parameters to generate a speech output corresponding to a text input received from the speech-to-text conversion unit.

17. The speech modification unit as in claim 16, further comprising a database for storing the plurality of speech parameters.

18. The speech modification unit as in claim 17, wherein the speech parameters are diphones.

19. The speech modification unit as in claim 17, further comprising:
a training unit coupled to the speech synthesis unit and to the speech-to-text conversion unit, the training unit receiving a speech sample and extracting speech parameters to store in the database.

20. The speech modification unit as in claim 19, wherein the speech-to-text unit provides phenome boundary information to the training unit.

21. The speech modification unit as in claim 20, wherein the training unit is activated during a training mode, and deactivated during a normal operating mode.
